(19) United States
(12) Patent Application Publication
(10) Pub. No.: US 2012/0184332 A1
(43) Pub. Date: Jul. 19, 2012

(54) MOBILE PHONE

(75) Inventor: MING-CHANG LEE, Tu-Cheng (TW)

(73) Assignee: HON HAI PRECISION INDUSTRY CO., LTD., Tu-Cheng (TW)

(21) Appl. No.: 13/075,207

(22) Filed: Mar. 30, 2011

(30) Foreign Application Priority Data
Jan. 19, 2011 (TW) 100101908

(51) Int. Cl. H04M 1/02; H04W 88/02

(52) U.S. Cl. 455/556.1

(57) ABSTRACT

A mobile phone includes a touch screen, a mobile phone chip, a switch, a remote controller chip, a storage unit, and a signal transmitting device. When the switch is turned on, pictures of first and second controlled objects are displayed on the touch screen by the mobile phone chip. When the first or second picture displayed on the touch screen is touched, the remote controller chip executes computerized instructions stored in the storage unit correspondingly. A number of function icons of the first or second controlled object are displayed on the touch screen. The remote controller chip outputs a control signal according to touched function icons. The signal transmitting device converts the control signal to wireless signals for remotely controlling the first or second controlled object.

### BACKGROUND

1. Technical Field

The present disclosure relates to a mobile phone.

2. Description of Related Art

Many electronic devices come with their own remote controller. As a result, when a household has many electronic devices, then there are many remote controllers, which can be troublesome and inconvenient.

### BRIEF DESCRIPTION OF THE DRAWINGS

Many aspects of the present embodiments can be better understood with reference to the following drawings. The components in the drawing are not necessarily drawn to scale, the emphasis instead being placed upon clearly illustrating the principles of the present embodiments. Moreover, in the drawing, all the views are schematic, and like reference numerals designate corresponding parts throughout.

FIG. 1 is a schematic, block diagram of an exemplary embodiment of a mobile phone, the mobile phone includes a storage unit.

FIG. 2 is a schematic, block diagram of the storage unit of FIG. 1.

FIG. 3 is a schematic diagram of the mobile phone of FIG. 1.

FIG. 4 is another schematic diagram of the mobile phone of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

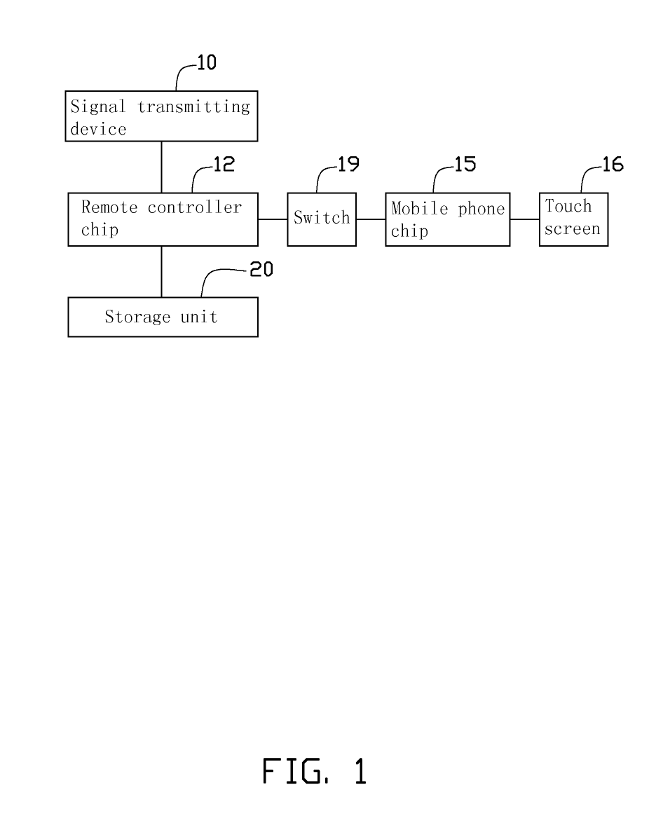

Referring to FIG. 1, an exemplary embodiment of a mobile phone includes a signal transmitting device 10, a remote controller chip 12, a mobile phone chip 15, a touch screen 16, a switch 19, and a storage unit 20.

The signal transmitting device 10 is connected to the remote controller chip 12 for receiving control signals from the remote controller chip 12 and converting the control signals to wireless signals. In the embodiment, the signal transmitting device 10 may be an infrared transmitter, a radio frequency (RF) transmitter, or a BLUETOOTH transmitter.

The mobile phone chip 15 is connected to the touch screen 16 for receiving touch signals from the touch screen 16. The mobile phone chip 15 is further connected to the remote controller 12 through the switch 19. When the switch 19 is turned off, the mobile phone chip 15 receives touch signals from the touch screen 16. At this time, the mobile phone works as a mobile phone with the touch screen. When the switch 19 is turned on, the mobile phone chip 15 receives touch signals from the touch screen 16, and processes the touch signals to obtain selecting signals. The mobile phone chip 15 then transmits the selecting signals to the remote controller chip 12.

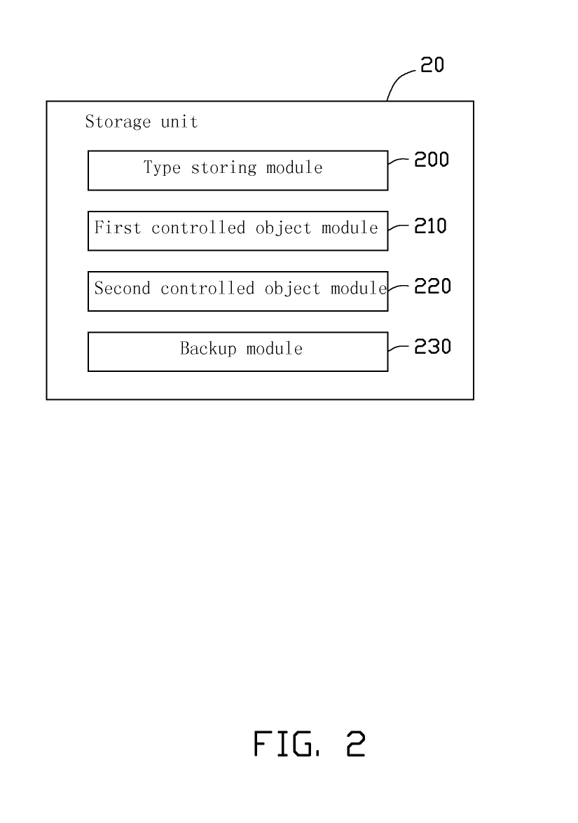

Referring also to FIG. 2, the storage unit 20 includes a type storing module 200, a first controlled object module 210, a second controlled object module 220, and a backup module 230 which may include one or more computerized instructions and are executed by the remote controller chip 12.

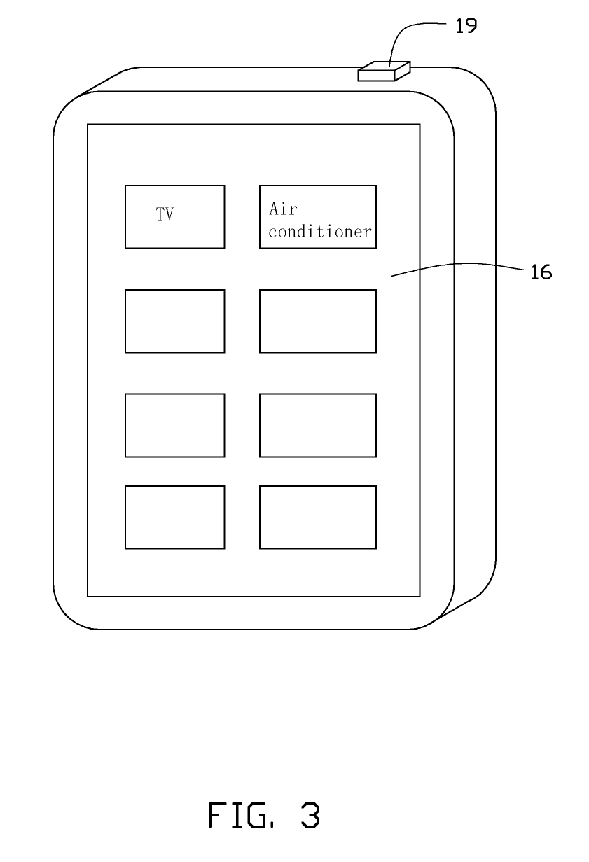

The type storing module 200 stores pictures of a first controlled object and a second controlled object. In other embodiments, the type storing module 200 may include pictures of more than two controlled objects. In addition, the storage unit 20 may include more than two controlled object modules, for controlling more than two kinds of electronic devices. When the switch 19 is turned on, the remote controller chip 12 executes computerized instructions stored in the type storing module 200, and transmits data to the mobile phone chip 15 through the switch 19. The touch screen 16 displays the two pictures which correspond to the first and second controlled objects respectively according to the data from the mobile phone chip 15. As shown in FIG. 3, the first controlled object is a television (TV) set, and the second controlled object is an air conditioner.

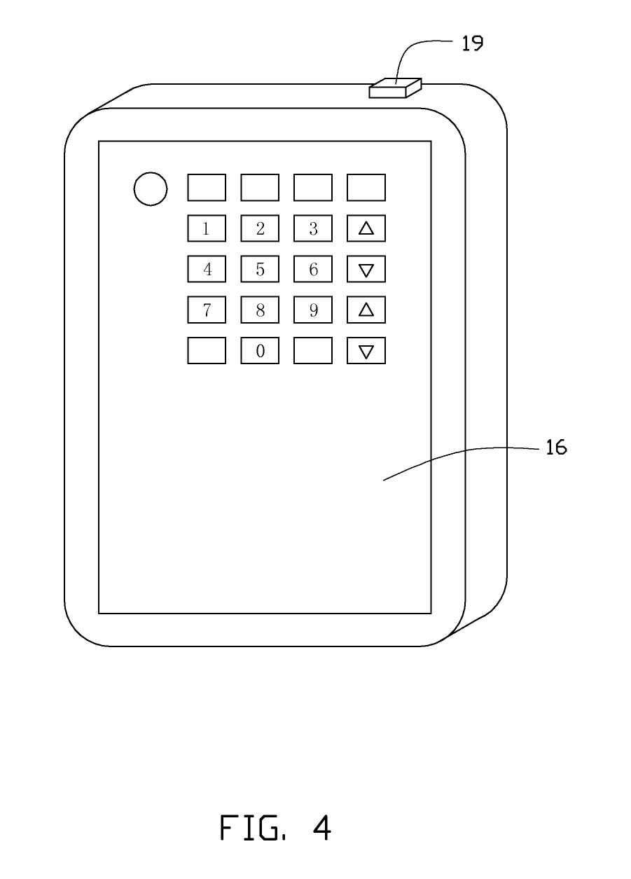

One of the two pictures is selected on the touch screen 16. For example, when a user wants to remotely control the TV set, the user touches the picture of the TV set on the touch screen 16. The touch screen 16 senses the touch, and transmits the touch signal to the mobile phone chip 15. The mobile phone chip 15 controls the remote controller chip 12 to execute computerized instructions stored in the first controlled object module 210 according to the touch signals. The first controlled object module 210 stores a plurality of function icons corresponding to the TV set, such as “Power on” and “Power off”. As shown in FIG. 4, the function icons are displayed on the touch screen 16 by the mobile phone chip 15.

When the user touches the “Power off” function icon on the touch screen 16, the touch screen 16 senses the touch and transmits the touch signal to the mobile phone chip 15. The mobile phone chip 15 processes the touch signal and outputs a power off signal to the remote controller chip 12. The remote controller chip 12 processes the power off signal and outputs the signal to the signal transmitting device 10 accordingly. The signal transmitting device 10 converts the signal to a wireless signal to turn off the TV set.

The backup module 230 is used for extending types of the controlled objects. When the user needs to add a new controlled object, datasheet of the new controlled object can be downloaded into the backup module 230 from a computer. Furthermore, an icon of the new controlled object is downloaded into the type storing module 200. In other embodiments, the storage unit 20 may include more than one backup module.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A mobile phone comprising:
a touch screen to sense touch signals;
a mobile phone chip to receive the touch signals from the touch screen;
a switch;
a remote controller chip connected to the mobile phone chip through the switch;
a storage unit connected to the remote controller chip and storing a plurality of programs to be executed by the remote controller chip, wherein the storage unit comprises:
a type storing module storing pictures of a first controlled object and a second controlled object, wherein when the switch is turned on, the pictures of the first and second controlled objects stored in the type storing module are displayed on the touch screen by the mobile phone chip;
a first controlled object module storing a plurality of function icons for the first controlled object; and
a second controlled object module storing a plurality of function icons for the second controlled object, wherein when the first or second picture displayed on the touch screen is selected, the plurality of function icons of the first or second controlled object are displayed on the touch screen correspondingly, the remote controller chip outputs a control signal according to the selected function icons; and
a signal transmitting device to convert the control signal to wireless signals for remotely controlling the first or second controlled object.

2. The mobile phone of claim 1, wherein the storage unit further comprises a backup module, the backup module stores a plurality of function icons of a third controlled object.

3. The mobile phone of claim 1, wherein the signal transmitting device is an infrared transmitter.

4. The mobile phone of claim 1, wherein the signal transmitting device is a Bluetooth transmitter.

5. The mobile phone of claim 1, wherein the signal transmitting device is a radio frequency transmitter.
